(19) United States
(12) Patent Application Publication
(10) Pub. No.: US 2003/0103136 A1
(43) Pub. Date: Jun. 5, 2003

(54) Method and system for 2D/3D illusion generation

(75) Inventor: Douglas A. Stanton, Ossining, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 10/012,018

(22) Filed: Dec. 5, 2001

(51) Int. Cl. H04N 9/47

(52) U.S. Cl. 348/49; 348/58

(57) ABSTRACT

Methods for simulating 3D video images using 2D video input are disclosed. The methods may include detecting a direction of a majority of spatial movement of the 2D video input, separating the 2D video input into left and right signals, and delay processing either the left or right signal based on the detected direction of the majority of spatial movement. The method may also include simultaneously displaying the left signal to the viewer's left eye and the right signal to the viewer's right eye after the delay processing.

### BACKGROUND OF THE INVENTION

1. Field of the Invention

The present invention generally relates to generation of the illusion of three dimensional (3D) images from a two dimensional (2D) video signal. The present invention specifically relates to time delaying the video signal when displayed as a stereoscopic 2D video image providing an illusion of a 3D image to the viewer.

2. Description of the Related Art

3D imagery is a function of binocular parallax, which provides relative depth perception to the viewer. As an image of a fixated object fall on disparate retinal points, the resulting retinal disparity provides stimulus from which the sense of stereopsis is created by the viewer's visual system. Within the visual system separate neurological subsystems specializing in different aspects of stereopsis such as fine or coarse stereopsis, or motion-in-depth, static or lateral motion stereopsis performing in combination or separately based upon the stimulus, create a 3D image for the viewer. Various means whereby 2D images may be presented to the viewer's visual system as 3D images currently in existence use such techniques as Random Dot and Autostereograms, (Wallpaper Phenomenon), Pulfrich Effect or Chromostereopsis. However, each of these techniques has shortcomings in generating the illusion of a 3D image from 2D media such as, the ability to use only a static fixated object, the requirement for diminished illumination or the inability to generate 3D images from a single 2D source containing motion. Each of these techniques involves the segregation of information to each eye, (strereoscopic viewing) and distinctly presents a different image to each eye. The visual system interprets this data as depth and integrates the separate 2D data as a 3D image. Each of these relies on inducing a temporal delay to one eye relative to the other eye.

In Random Dot and Autostereograms the patterns must be repetitive, the eyes must converge within one repetitive pattern width and left and right eye images must contain disparities. The segregation may also be achieved utilizing polaroids, filtered lenses or chromosaturation, also known as chromostereopsis. However, this method is limited to static 2D visual displays, pictures, posters, etc. and the prolonged viewing tends to produce eyestrain and discomfort for the viewer.

The Pulfrich Effect is based upon using a neutral density filter to reduce the illumination available to one eye, which gives rise to a temporal delay, as the affected eye shifts from rod mode to cone mode. As the cones require more time to gather light and present a delayed image to the visual system upon integration with the image from the unaffected eye, a 3D image is simulated. The Pulfrich Effect requires that the fixated object exhibit discernible horizontal motion to generate the phenomenon, as a still object will present the same relative position information to both affected and unaffected eyes. However, this method requires the diminished illumination to one of either left or right eyes of the viewer and relies exclusively on motion in the horizontal plane. Further, this method tends to produce a 3D image principally biased to motion in the direction of the eye receiving diminished illumination. The 3D image produced based on motion toward the unaffected eye is minimally distinguishable.

Chromostereopsis generates the illusion of a 3D image through the saturation of red and blue colors within a 2D format. This is a function of chromatic aberration of the eye and requires the optic axis to be offset from the visual axis thereby giving rise to the illusion of a 3D image. This method is limited to the presentation of static 2D media such as pictures, posters, etc.

Presently, 3-D stereoscopic images are generated from stereoscopic video input or computer generated programs designed to provide separate video channels to each eye of the viewer. The disparate stereoscopic images are produced by a number of methods. One such device utilizes a series of cameras, each camera having a different viewing angle relative to the viewed object, each input provided a distinct filter specific for that channel to record the image. These channels are then played back simultaneously on a common display and the viewer wearing lenses with filters specific to each of the channels observes the 2D images as 3D due to the Pulfrich Phenomena. This is a direct response of temporal delay introduced to the viewer's binocular stereopsis within the range of 2-10 arc seconds to the maximum of Panum's Limit, (6-10 arc minutes foveally). Foveally is herein defined as the angular measurement relative to the central fovea of the retina. However, this technique is limited to the requirement for two or more simultaneous disparate 2D video input signals and is incapable of displaying a single 2D video input as a 3D image.

Another device utilizes electronically shuttered lenses that sense the viewer's head motion relative to the viewing screen and that presents both left and right channels simultaneously. This device as the previously mentioned one rely upon the disparate stereo video input source signals which are separately conditioned using an optical grating or signal processor to permit both channels to be displayed simultaneously while maintaining their distinct attributes. Other current devices exist that utilize differing filters or lenses to present the separate channels to the viewer's left and right eyes to obtain the illusion of 3D. These devices all seek to reduce the illumination to one of the viewer's left or right eyes to produce a 3D image. Further, these techniques depend upon a video display having a disparate left and right display generated from two or more discrete 2D video inputs simultaneously provided to the common display.

Another device is found in the virtual reality display system that utilizes two or more video inputs and retards the signal displayed to each channel based upon algorithms within the CPU to present discrete signals to each display unit of the viewer's eyes, therein creating the illusion of a 3D image. This differs from those mentioned earlier as the signal processing may be integrated with graphic software to increase the depth of field through such graphic enhancement techniques as Chiaroscuro, Background Blurring, Texture Gradient, Motion Parallax and Perspective to various degrees. However, this technique does not have the ability to utilize a single 2D video input to generate the illusion of a 3D image.

Other current devices include Lenticular Film, Anaglyphs and Multiplex Holograms all of which require that two or more disparate video inputs be provided to generate a 3D image and do not have the ability to utilize a single 2D video input.

It would be desirable to have a system, which overcomes the above disadvantages.

### SUMMARY OF THE INVENTION

The present invention relates to methods and systems for simulating 3D images from 2D video input. Various aspects of the invention are novel, non-obvious, and provide various advantages. While the actual nature of the present invention covered herein may only be determined with reference to the claims appended hereto, certain features, which are characteristic of the embodiments disclosed herein, are described briefly as follows.

One aspect of the present invention provides a method for simulating 3D video images to a viewer from a 2D video input signal that includes detecting a direction of a majority of spatial movement of the 2D video input, separating the 2D video input into left and right signals, delay processing either the left or right signal based on the detected direction of the majority of spatial movement of the 2D video input; and simultaneously displaying the left signal to the viewer's left eye and the right signal to the viewer's right eye after the delay processing. In this method the motion detector may detect direction in the horizontal plane and the delay processing may be based upon a coefficient of eye response that may correspond to a range of 2 arc seconds to 10 arc minutes foveally.

Another aspect of the invention provides a system for simulating 3D images from a 2D video input signal that includes a signal processor, a video splitter operably connected to the signal processor, a motion detector operably connected to the signal processor; and a video display operably connected to the signal processor. In this system, the signal processor delays one of a right video signal or a left video signal received from the video splitter based on a majority of special movement detected by the motion detector and simultaneously displays the left video signal to a viewer's left eye and the right video signal to the viewer's right eye after the delay processing.

Another aspect of the invention provides a method for simulating 3D video images to a viewer from a 2D video input signal that may include detecting a direction of a majority of spatial movement of the 2D video input signal, separating the 2D video input signal into a left signal and a right signal, and delay processing one of the left signal and right signal based on the detected direction of the majority of spatial movement of the 2D video input signal. This method may also include oppositely polarizing the left signal and right signal; and simultaneously displaying the left signal and right signal to a common display after the delay processing. Further, the motion detector may detect direction in the horizontal plane and the delay processing may be based upon a coefficient of eye response that may correspond to a range of 2 arc seconds to 10 arc minutes foveally.

Another aspect of the present invention provides a system for simulating 3D video images to a viewer from 2D video input that includes means for detecting a direction of a majority of spatial movement of the 2D video input, means for separating the 2D video input into left and right signals, means for delay processing one of the left and right signals based on the detected direction of the majority of spatial movement of the 2D video input; and means for oppositely polarizing the left and right video output signals. This system may also include means for simultaneously displaying the left signal and the right signal, after oppositely polarizing and means for viewing the display.

Another aspect of the present invention provides a system for generating 3D images from a 2D video input signal that may include a signal processor, a video splitter to separate the 2D video input signal into a left video signal and right video signal operably connected to the signal processor, a motion detector operably connected to the signal processor, and a video display operably connected to the signal processor. Further, the signal processor may delay one of the right and left video signals received from the video splitter based on a majority of spatial movement detected by the motion detector and oppositely polarizes and simultaneously displays the right and left signals to a common display. This aspect of the present invention may also include an oppositely polarized lens for each the viewer's eyes for viewing the video display.

The foregoing forms and other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 is a block diagram of one embodiment of a 2D to 3D illusion generation system in accordance with the present invention;

FIG. 2 is a flowchart of one embodiment illustrating a method of 2D to 3D illusion generation in accordance with the present invention;

FIG. 3 is a flowchart of one embodiment illustrating a routine for signal processing of 2D video inputs to generate a 3D illusion in accordance with the present invention;

FIG. 4 is a block diagram of one embodiment of 2D to 3D illusion generation system in accordance with the present invention;

FIG. 5 is a flowchart of one embodiment illustrating a method of 2D to 3D illusion generation in accordance with the present invention;

FIG. 6 is a flowchart of one embodiment illustrating a routine for signal processing of 2D video inputs to generate a 3D illusion in accordance with the present invention.

### DETAILED DESCRIPTION OF THE PRESENTLY PREFERRED EMBODIMENTS

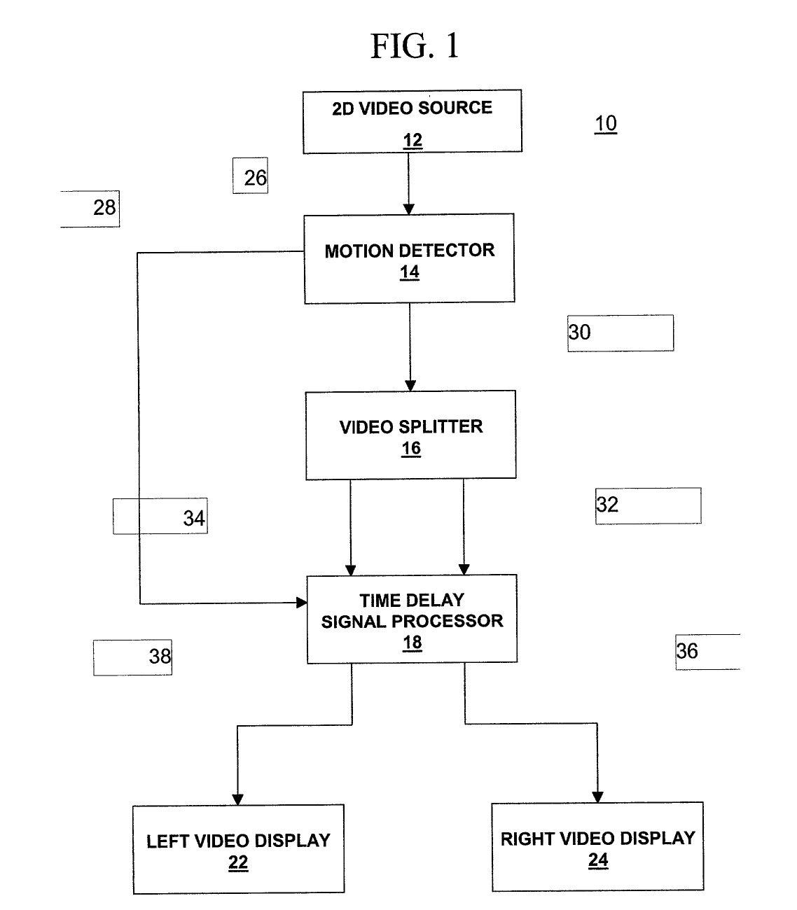

FIG. 1 illustrates one embodiment of a method of two dimensional (2D) to three dimensional (3D) illusion generation in accordance with the present invention.

Referring to FIG. 1 one embodiment of a 2D/3D illusion generation system is generally shown at number 10. The illusion generation system 10 may include a motion detector 14, a video splitter 16, a time delay signal processor 18, a left video display 22 and a right video display 24. The system 10 may receive a 2D video signal from a 2D video source 12. The 2D video source 12 may generate for signal a television signal, VCR signal, DVD signal, digital camera signal, or any 2D video signal. The 2D video source 12 may be operably connected to the motion detector 14. The motion detector 14 may analyze a majority of the relative motion of the 2D video signal 26. The motion detector 14 may be any motion detector known in the art for detecting the direction of a majority of the motion of a 2D video signal 26. The motion detector 14 may output an analyzed 2D video signal 30. The motion detector 14 may output a motion output signal 28 indicating the direction of a majority of spatial movement of the 2D video signal 26 to the time delay signal processor 18. In one embodiment the motion detector 14 may analyze the majority of the horizontal motion from the 2D video signal 26. The motion detector 14 may be operably connected to the time delay signal processor 18 and a video splitter 16.

The video splitter 16 may split a 2D video signal 30 into a right video signal 32 and a left video signal 34. In another embodiment the video splitter 16 may receive the 2D video signal 26 and may split the video signal 26 into a right video signal 32, left video signal 34 and a 2D video input motion signal. The video splitter 16 may be any video splitter known in the art. The video splitter 16 may be operably connected to the time delay signal processor 18. In another embodiment the video splitter 16 may be operably connected to a 2D video source 12, a motion detector 14 and a time delay signal processor 18.

The time delay signal processor 18 may receive the right video signal 32, left video signal 34 and motion output signal 28. The time delay signal processor 18 may time delay one of either the right video signal 32 and left video signal 34 based on the indicated direction of the motion output signal 28. In one embodiment the time delay signal processor 18 may have an adjustable time delay period that corresponds to a viewer's coefficient of eye response. The time delay signal processor 18 may simultaneously output a right video signal 36 and a left video signal 38 to a corresponding right video display 24 and a left video display 22. The time delay signal processor 18 may be any signal processor known in the art. The time delay signal processor 18 may be operably connected to the right video display 24 and the left video display 22.

The right video display 24 may receive a right video signal 36. The right video display 24 may display the right video signal 36 as a 2D video image to a viewer's right eye. The left video display 22 may receive a left video signal 38. The left video display 22 may display the left video signal 38 as a 2D image to the viewer's left eye. The right video display 24 and the left video display 22 may be stereoscopically viewed simultaneously and may create the illusion of a 3D image.

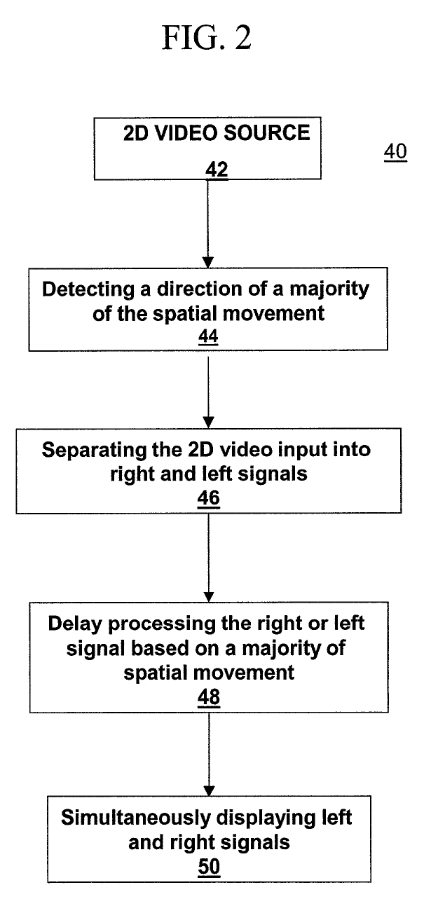

FIG. 2 illustrates one embodiment of a method of 2D to 3D illusion generation in accordance with the present invention.

Referring to FIG. 2 one embodiment of a method of 3D illusion generation is generally shown at number 40. A 2D video signal 26 from a video source 12 (block 42) may be analyzed by a motion detector 14 to detect the direction of a majority of spatial motion (block 44). The motion detector 14 may output a motion signal 28 indicating the direction of the majority of the spatial motion to a time delay signal processor 18. The motion detector 14 may output the analyzed 2D video signal 30 to a video splitter 16. The video splitter 16 may receive a 2D video signal 30 from the motion detector 14 and may split the 2D video signal 30 into a right video signal 32 and a left video signal 34 (block 46). The time delay signal processor 18 may receive the right video signal 32, the left video signal 34 from the video splitter 16 and the motion signal 28 from the motion detector 14. The time delay signal processor 18 may also delay either one of the right video signal 32 and the left video signal 34 depending on an indication from the motion signal 28 in accordance with the direction of the majority of spatial movement (block 48). The signal processor 18 may simultaneously output the right video signal 36 and the left video signal 38 to a right video display 24 and a left video display 22. The right video display 24 may receive the right video signal 36 from the time delay signal processor 18. The left video display 22 may receive the left video signal 38 from the time delay signal processor 18. Both left video display 22 and right video display 24 may simultaneously display the right video signal 36 and left video signal 38 as disparate 2D video images, which may be viewed stereoscopically by the viewer and may create the illusion of a 3D image under full illumination (block 50).

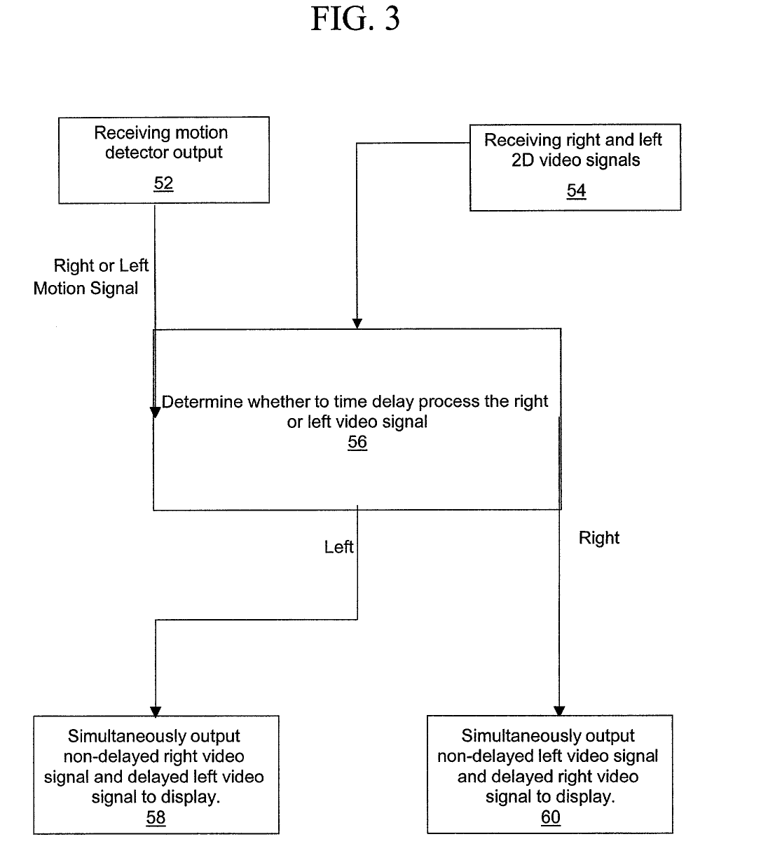

FIG. 3 illustrates one embodiment of a routine for time delay processing a 2D video input signal in accordance with the present invention.

Referring to FIG. 3, one embodiment of a routine for processing the right video signal 32 and left video signal 34 received at time delay signal processor 18 is generally shown. The time delay signal processor 18 may receive a motion detector output signal 28 (block 52) and a right video signal 32 and a left video signal 34 (block 54). In one embodiment the delay processor 18 determines whether to time delay process either the right video signal 32 or the left video signal 34 based on the direction of a majority of the spatial movement indicated by the motion detector signal 28 (block 56). In one embodiment the time delay signal processor 18 may determine the right video input 32 to be delayed based on the direction input from the motion detector output signal 28 (block 56). After delay processing the time delay signal processor 18 may simultaneously output the non-delayed left video signal 38 to a left video display 22 and the delayed right video signal 36 to a right video display 24 (block 60). Alternately, if the motion detector signal 28 indicates that the direction of a majority of the spatial movement is left the signal processor 18 may time delay the left video signal 34. After delay processing the time delay signal processor 18 may simultaneously output the non-delayed right video signal 36 to the right video display 24 and the delayed left video signal 38 to the left video display 22 (block 58). In one embodiment, the time delay signal processor 18 may have an adjustable range of 2 arc seconds to 10 arc minutes foveally, this time range is equivalent to the coefficient of eye response for time delaying either one of the right video signal 36 and left video signal 38, which may permit adjustment of the 3D video image to better suit a viewer.

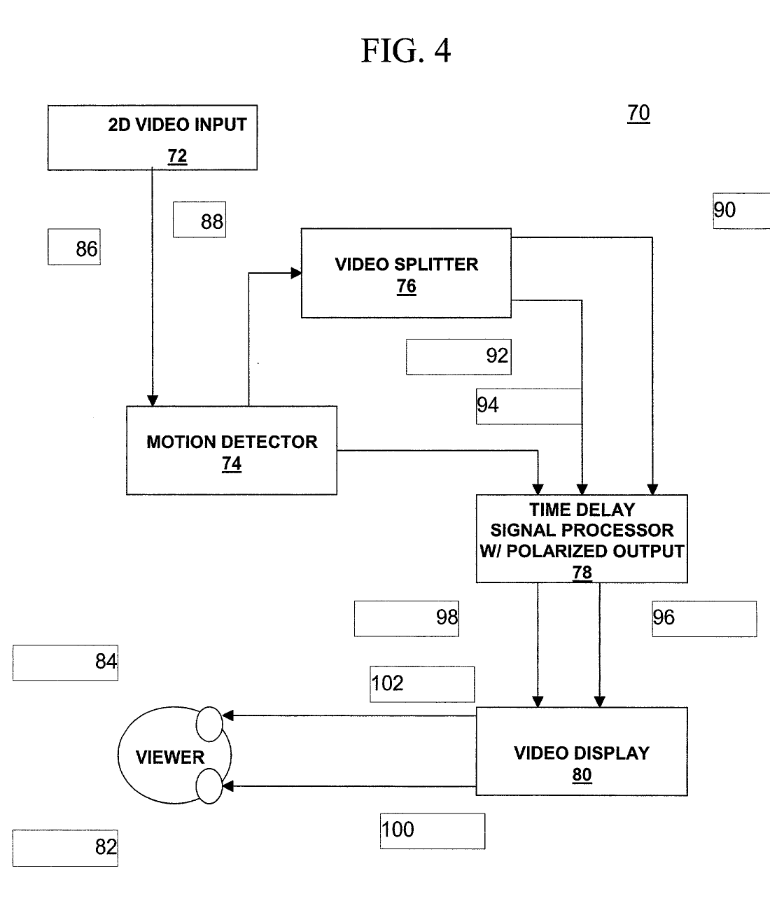

FIG. 4 illustrates one embodiment of a method of two dimensional (2D) to three dimensional (3D) illusion generation in accordance with the present invention.

Referring to FIG. 4 one embodiment of a 2D/3D illusion generation system is generally shown at number 70. The illusion generation system 70 may include a motion detector 74, a video splitter 76, a time delay signal processor with polarized output 78, a video display 80, oppositely polarized right lens 82 and left lens 84. The system 70 may receive a 2D video signal from a 2D video source 72. The 2D video source 72 may generate for signal a television signal, VCR signal, DVD signal, digital camera signal, or any 2D video signal. The 2D video source 72 may be operably connected to the motion detector 74. The motion detector 74 may analyze a majority of the relative motion of the 2D video signal 86. The motion detector 74 may be any motion detector known in the art for detecting the direction of a majority of the motion of a 2D video signal 86. The motion detector 74 may output an analyzed 2D video signal 88. The motion detector 74 may output a motion output signal 94 indicating the direction of a majority of spatial movement of the 2D video signal 86 to the time delay signal processor 78. In one embodiment the motion detector 74 may analyze the majority of the horizontal motion from the 2D video signal 86. The motion detector 74 may be operably connected to the time delay signal processor 78 and the video splitter 76.

The video splitter 76 may split a 2D video signal 88 into a right video signal 90 and a left video signal 92. In another embodiment the video splitter 76 may receive the 2D video signal 86 and may split the video signal 86 into a right video signal 90, left video signal 92 and a 2D video input motion signal. The video splitter 76 may be any video splitter known in the art. The video splitter 76 may be operably connected to the time delay signal processor 78. In another embodiment the video splitter 76 may be operably connected to a 2D video source 72, a motion detector 74 and a time delay signal processor 78.

The time delay signal processor 78 may receive the right video signal 90, left video signal 92 and motion output signal 94. The time delay signal processor 78 may time delay one of either the right video signal 90 and left video signal 92 based on the indicated direction of the motion output signal 94. In one embodiment the time delay signal processor 78 may have an adjustable time delay period that corresponds to a viewer's coefficient of eye response. After time delay processing one of either the right video signal 90 and the left video signal 92 the time delay signal processor 78 may oppositely polarize the right video signal 90 and left video signal 92. After oppositely polarizing the right video signal 90 and left video signal 92 the time delay signal processor 78 may simultaneously output the oppositely polarized right video signal 96 and a left video signal 98 to a common video display 80. The time delay signal processor 78 may be any signal processor known in the art. The time delay signal processor 78 may be operably connected to the common video display 80.

The video display 80 may receive an oppositely polarized right video signal 96 and a left video signal 98. The video display 80 may simultaneously display the oppositely polarized right video signal 96 and the left video signal 98 as an oppositely polarized 2D right video image 100 to a viewer's right eye and an oppositely polarized 2D left video image 102 to a viewer's left eye. The right video image 100 and left video image 102 may be stereoscopically viewed by an oppositely polarized right lens 82 and a left lens 84 simultaneously to create the illusion of a 3D image.

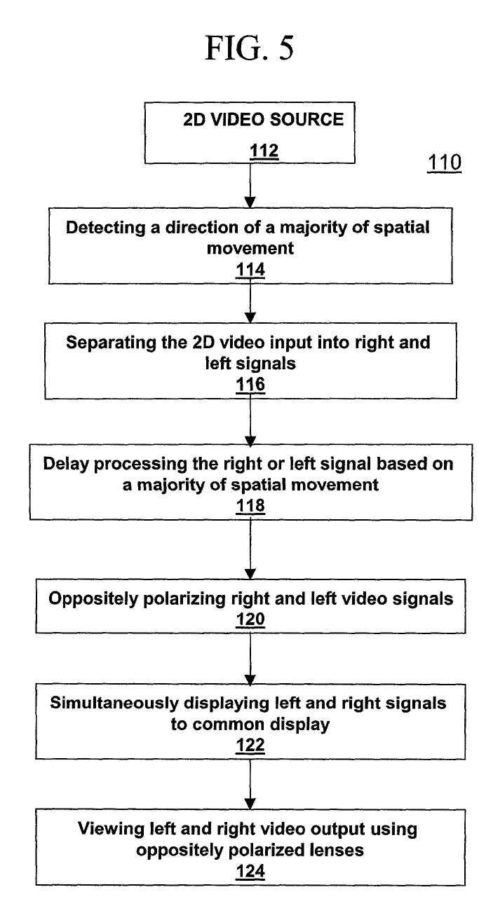

FIG. 5 illustrates one embodiment of a method of 2D to 3D illusion generation in accordance with the present invention.

Referring to FIG. 5 one embodiment of a method of 3D illusion generation is generally shown at number 110. A 2D signal video signal 86 from a video source 72 (block 112) may be analyzed by a motion detector 74 to detect the direction of a majority of spatial motion (block 114). The motion detector 74 may output a motion signal 94 indicating the direction of the majority of spatial motion to a time delay signal processor 78. The motion detector 74 may output the analyzed 2D video signal 88 to a video splitter 76. The video splitter 76 may receive a 2D video signal 88 from the motion detector 74 and may split the 2D video signal 88 into a right video signal 90 and a left video signal 92 (block 116). The time delay signal processor 78 may receive the right video signal 90, the left video signal 92 from the video splitter 76 and the motion signal 94 from the motion detector 74. The time delay signal processor 78 may also delay either one of the right video signal 90 and the left video signal 92 depending on an indication from the motion signal 94 in accordance with the direction of the majority of spatial movement (block 118). After delay processing the right video signal 90 and left video signal 92 the signal processor 78 may oppositely polarize the right video signal 90 and left video signal 92 (block 120). After oppositely polarizing the right video signal 90 and left video signal 92 the signal processor 78 may simultaneously output the oppositely polarized right video signal 96 and the left video signal 98 to a common video display 80. The common video display 80 may receive the oppositely polarized right video signal 96 and left video signal 98 from the time delay signal processor 78. The common video display 80 may simultaneously display the oppositely polarized right video signal 96 and left video signal 98 as an oppositely polarized 2D right video image 100 and left video image 102 (block 122). The right video image 100 and the left video image 102 which may be viewed stereoscopically by the viewer using oppositely polarized right lens 82 and left lens 84 and may create the illusion of a 3D image under full illumination (block 124).

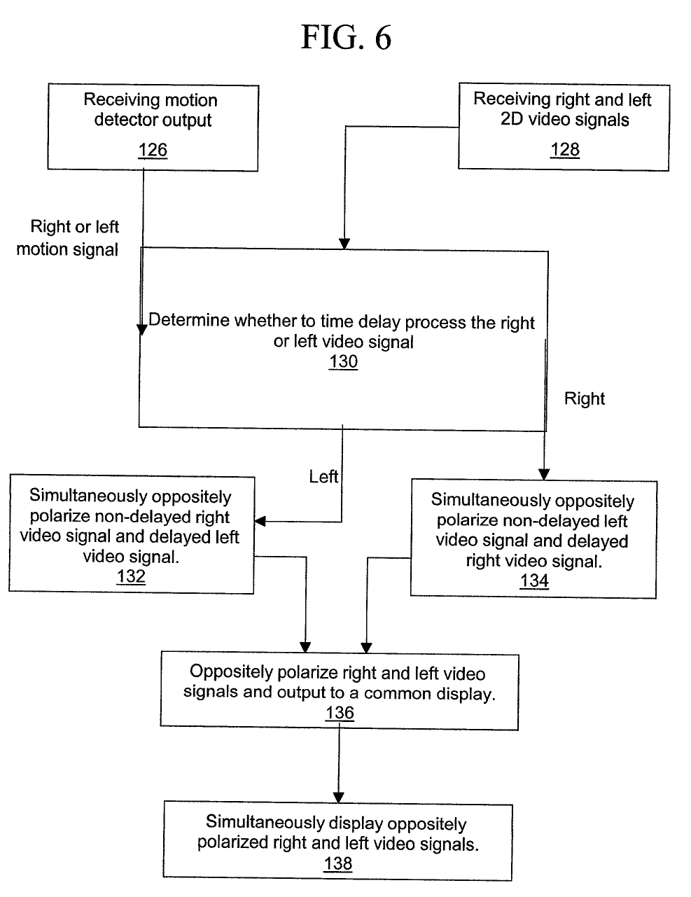

FIG. 6 illustrates one embodiment of a routine for time delay processing a 2D video input signal in accordance with the present invention.

Referring to FIG. 6, one embodiment of a routine for processing the right video signal 90 and left video signal 92 received at time delay signal processor 78 is generally shown. The time delay signal processor 78 may receive a motion detector output signal 94 (block 126) and a right video signal 90 and a left video signal 92 (block 128). In one embodiment the delay processor 78 determines whether to time delay process either the right video signal 90 or the left video signal 92 based on the direction of a majority of spatial movement indicated by the motion detector signal 94 (block 130). In one embodiment the time delay signal processor 78 may determine the right video input 90 to be delayed based on the direction input from the motion detector output signal 94 (block 130). After time delay processing the signal processor 78 may simultaneously oppositely polarize the delayed right video signal 90 and the non-delayed left video signal 92 (block 134). After oppositely polarizing the delayed right video signal 90 and the non-delayed left video signal 92 the time delay signal processor 78 may simultaneously output the non-delayed left video signal 98 and the delayed right video signal 96 to a common video display 80 (block 136). Alternately, if the motion detector signal 94 indicates that the direction of a majority of the spatial movement is left the signal processor 78 may time delay the left video signal 92. After time delay processing the signal processor 78 may simultaneously oppositely polarize the delayed left video signal 92 and the non-delayed right video signal 90 (block 132). After oppositely polarizing the delayed left video signal 92 and the non-delayed right video signal 90 the time delay signal processor 78 may simultaneously output the non-delayed right video signal 96 and the delayed left video signal 98 to a common video display 80 (block 136). In one embodiment, the time delay signal processor 78 may have an adjustable range of 2 arc seconds to 10 arc minutes foveally, this time range is equivalent to the coefficient of eye response for time delaying either one of the right video signal 96 and left video signal 98, which may permit adjustment of the 3D video image to better suit a viewer. The video display 80 may receive an oppositely polarized right video signal 96 and left video signal 98 from the time delay signal processor 78. The video display 80 may simultaneously display the oppositely polarized right video signal 96 and left video signal 98 as an oppositely polarized right video image 100 and left video image 102 (block 138). The oppositely polarized right video image 100 and left video image 102 when viewed stereoscopically using oppositely polarized right lens 82 and left lens 84 create a 3D image to the viewer.

While the embodiments of the present invention disclosed herein are presently considered to be preferred, various changes and modifications may be made without departing from the spirit and scope of the present invention. The scope of the present invention is indicated in the appended claims, and all changes that come within the meaning and range of equivalents are intended to be embraced therein.

1. A method for simulating 3D video images to a viewer from 2D video input comprising:
detecting a direction of a majority of spatial movement of the 2D video input;
separating the 2D video input into left and right signals;
delay processing one of the left and right signals based on the detected direction of the majority of spatial movement of the 2D video input; and
simultaneously displaying the left signal to the viewer's left eye and the right signal to the viewer's right eye after the delay processing.

2. The method of claim 1 wherein the detected direction is in the horizontal plane.

3. The method of claim 1 wherein the delay processing is based upon a coefficient of eye response.

4. The method of claim 3 wherein the coefficient of eye response has a scalable range corresponding to 2 arc seconds to 10 arc minutes foveally.

5. A system for simulating 3D video images to a viewer from 2D video input comprising:
means for detecting a direction of a majority of spatial movement of the 2D video input;
means for separating the 2D video input into left and right signals;
means for delay processing one of the left and right signals based on the detected direction of the majority of spatial movement of the 2D video input; and
means for simultaneously displaying the left signal to the viewer's left eye and the right signal to the viewer's right eye after the delay processing.

6. A system for generating 3D images from a 2D video input signal comprising:
a signal processor;
a video splitter operably connected to the signal processor;
a motion detector operably connected to the signal processor; and
a video display operably connected to the signal processor,
wherein the signal processor delays one of a right video signal or a left video signal received from the video splitter based on a majority of special movement detected by the motion detector and simultaneously displays the left video signal to a viewer's left eye and the right video signal to the viewer's right eye after the delay processing.

7. A method for simulating 3D video images to a viewer from 2D video input signal comprising:
detecting a direction of a majority of spatial movement of the 2D video input signal;
separating the 2D video input signal into a left signal and a right signal;
delay processing one of the left signal and right signal based on the detected direction of the majority of spatial movement of the 2D video input signal;
oppositely polarizing the left signal and right signal; and
simultaneously displaying the left signal and right signal to a common display after the delay processing.

8. The method of claim 7 further comprising:
viewing the common display using oppositely polarized right and left lenses.

9. The method of claim 7 wherein the detected direction is in the horizontal plane.

10. The method of claim 7 wherein the delay processing is based upon a coefficient of eye response.

11. The method of claim 10 wherein the coefficient of eye response comprises a scalable range of 2 arc seconds to 10 arc minutes foveally.

12. A system for simulating 3D video images to a viewer from 2D video input comprising:
means for detecting a direction of a majority of spatial movement of the 2D video input;
means for separating the 2D video input into left and right signals;
means for delay processing one of the left and right signals based on the detected direction of the majority of spatial movement of the 2D video input; and
means for oppositely polarizing the left and right video output signals.

13. The system of claim 12 further comprising;
means for simultaneously displaying the left signal and the right signal, after oppositely polarizing.

14. The system of claim 12 further comprising:
means for viewing the display.

15. A system for generating 3D images from a 2D video input signal comprising:
a signal processor;
a video splitter to separate the 2D video input signal into a left video signal and right video signal operably connected to the signal processor;
a motion detector operably connected to the signal processor; and
a video display operably connected to the signal processor;
wherein the signal processor delays one of the right and left video signals received from the video splitter based on a majority of spatial movement detected by the motion detector and oppositely polarizes and simultaneously displays the right and left signals to a common display.

16. The system of claim 15 further comprising:
an oppositely polarized lens for each of a left eye and a right eye for viewing the video display.

17. A computer usable medium storing a program for simulating a 3D video output signal from a 2D video input signal comprising:
computer readable code for detecting a direction of a majority of spatial movement of the 2D video input signal;
computer readable code for separating the 2D video input into a left signal and a right signal;
computer readable code for delay processing one of the left signal and the right signal based on the detected direction of the majority of spatial movement of the 2D video input signal; and
computer readable code for simultaneously displaying the left signal and the right signal after the delay processing.

18. The computer usable medium of claim 17 wherein the time delay is programmable over a scalable range corresponding to 2 arc seconds to 10 arc minutes foveally.

19. The computer usable medium of claim 17 wherein the motion detection is programmable corresponding to a scalable range of 0 to 100% of a majority of spatial movement.

20. The computer usable medium of claim 17 wherein the detected direction is in the horizontal plane.

21. The computer usable medium of claim 17 further comprising:
oppositely polarizing the right video signal and the left video signal prior to the simultaneous display.

22. The computer usable medium of claim 21 wherein the simultaneous display is to a common screen.

23. The computer usable medium of claim 21 wherein the left signal is displayed to the left eye and the right signal is displayed to the right eye.
